(19) United States
(12) Patent Application Publication
(10) Pub. No.: US 2026/0258984 A1
(43) Pub. Date: Sep. 3, 2026

(54) CRYOGENIC COOLING SYSTEM WITH ACTIVE HEAT EXCHANGER

(71) Applicant: Bluefors Oy, Helsinki (FI)

(72) Inventors: Lief ROSCHIER, Helsinki (FI); Benjamin ALLDRITT, Helsinki (FI)

(73) Assignee: Bluefors Oy, Helsinki (FI)

(21) Appl. No.: 19/164,609

(22) PCT Filed: Mar. 21, 2024
(86) PCT No.: PCT/FI2024/050138

§ 371 Date: Sep. 12, 2025

(30) Foreign Application Priority Data
Mar. 24, 2023 (EP) 23163965.9

(51) Int. Cl. F25B 9/10; F25B 9/12; F25B 21/02

(52) U.S. Cl. CPC F25B 9/10; F25B 9/12; F25B 21/02

(57) ABSTRACT

A cryogenic cooling system comprises a dilution refrigerator with a mixing chamber (401), a still (402), and a circulation arrangement for circulating working fluid through said mixing chamber (401) and still (402). At least one active heat exchanger (408, 801, 802, 901) has a first end and a second end and that is configured to use input energy to transfer heat from the first end to the second end during operation. Said first and second ends of the at least one active heat exchanger (408, 801, 802, 901) are thermally coupled to respective positions along said circulation arrangement for transferring heat between respective portions of the circulated working fluid.

### FIELD OF THE INVENTION

The invention is generally related to the cooling of cryostats. In particular, the invention is related to structural solutions and refrigeration mechanisms that enable cooling a cryostat efficiently, with reasonable consequences in structural complexity.

### BACKGROUND OF THE INVENTION

Early cryostats were cooled with liquid cryogens, such as liquid nitrogen and liquid helium. Later, mechanical cooling devices such as Stirling cryocoolers, Gifford-McMahon coolers, Pulse Tube Refrigerators (PTRs), and Joule-Thomson coolers have been introduced to implement so-called cryogen-free cooling. If the core part of the cryostat comprises a further cooling system such as a dilution refrigerator, which only becomes operative at temperatures at and below about 4 K, the required pre-cooling may be made with for example a PTR. In a typical case, the PTR has two cooling stages, of which the first stage is used to achieve a temperature around 40K-70K and the second stage pre-cools the still of the dilution refrigerator to the required 3K-4K level.

FIG. 1 is a simplified schematic illustration of a cryostat that is equipped with a dilution refrigerator and a mechanical pre-cooler. The outermost structure of the cryostat is a vacuum enclosure 101, which is shown with dashed lines in FIG. 1. The topmost flange 102 is the lid of the vacuum enclosure. The room temperature stage 103 of the mechanical pre-cooler is attached thereto. The first stage 104 of the mechanical pre-cooler is attached to a first flange 105 and the second stage 106 of the mechanical pre-cooler is attached to a second flange 107. The first and second flanges may be called the 50 K flange and the 4 K flange for example, reflecting their temperatures during operation.

Further below there are more flanges, like the still flange 108 to which the still 109 of the dilution refrigerator is attached. In FIG. 1 the mixing chamber 110 of the dilution refrigerator is attached to the base temperature flange 111. There may be one or more inter-mediate flanges between the still flange 108 and the base temperature flange 111, although none are shown in FIG. 1 for graphical clarity. Reference designator 112 illustrates the target region for a payload that is to be refrigerated. The payload is frequently referred to as the sample, and it should be firmly attached to the base temperature flange 111 in order to ensure as good thermal conductance as possible.

Cylindrical radiation shields, which are not shown in FIG. 1 for graphical clarity, are typically attached to the flanges in a nested configuration. Aligned apertures may exist in the flanges to provide, together with a cover 113 at the top, a so-called line-of-sight port to the target region 112. If fast sample exchanging is desired, there may be a sample changer for passing a sample to the target region 112 through the aligned apertures without having to warm up and open the whole cryostat. A sample changer may be of a top-loading type, which would be applicable in FIG. 1, or of bottom-loading type.

FIG. 2 illustrates schematically the major parts of a dilution refrigerator. The coldest part is the mixing chamber 110, in which a phase boundary 201 separates a concentrated phase 202 and a diluted phase 203 of the He3-He4 mixture. A circulation of He3 is maintained with a pump (not shown). On the path of the inbound stream of He3 there are flow impedances 204 and 205, as well as heat exchangers for cooling the helium that flows towards the mixing chamber 110. Shown in FIG. 2 are a first heat exchanger 206 in which the helium mixture and He3 vapour in the still 109 cool the inbound stream, and a second heat exchanger 207 in which the outbound stream of He3 cools the inbound stream. A heater 208 is provided to ensure a proper amount of He3 evaporation in the still 109.

FIG. 3 illustrates heat flows between the parts shown in FIG. 2. On the lowest level, the endothermic process of He3 moving across the phase boundary into the dilute phase makes heat flow from the payload 301 to the mixing chamber 110. On the level of the second heat exchanger 207, heat flows from the warmer, inbound stream of He3 to the colder, outbound stream. On the level of the still 109, heat flows both from the inbound stream 304 and from the heater 208 to the still. The inbound stream is marked with a different reference designator 304 to emphasize its slightly different temperature and interactions, even if it is the same inbound stream of He3 as on the middle level.

Dilution refrigerators have inherently a relatively low cooling power. Any attempt to increase the cooling power by e.g. increasing the rate at which He3 is circulated typically results in not being capable of reaching as low base temperatures as with a more modest flow rate. As the trends in cryogenic cooling are towards larger payloads and consequently larger requirements of cooling power, any developments would be welcome with which the cooling power could be increased without having to sacrifice the achievable base temperature level.

### SUMMARY

It is an objective to present a cryostat and a method for cooling a cryostat that solve the problem of larger heat loads in an advantageous and technically straightforward way. Another objective is to ensure that the solution is scalable towards even larger cryostats. A further objective is to solve the problem of increased heat loads without sacrificing reliability in operation. A yet further objective is to combine effective cooling with only a reasonable increase in structural complicatedness.

These and further advantageous objectives are achieved by utilising an active heat exchanger in combination with helium flows that provide a working fluid for cooling.

According to a first aspect, there is provided a cryogenic cooling system that comprises a dilution refrigerator. Parts of said dilution refrigerator are a mixing chamber, a still, and a circulation arrangement for circulating working fluid through said mixing chamber and still. The cryogenic cooling system comprises at least one active heat exchanger that has a first end and a second end and that is configured to use input energy to transfer heat from the first end to the second end during operation. Said first and second ends of the at least one active heat exchanger are thermally coupled to respective positions along said circulation arrangement for transferring heat between respective portions of the circulated working fluid.

According to an embodiment, among said at least one active heat exchangers is at least one of:
a solid-state microrefrigerator based on normal metal—insulator—superconductor tunnel junctions, referred to as a NIS refrigerator below,
a solid-state microrefrigerator based on superconductor—insulator—normal metal—insulator—superconductor tunnel junctions, referred to as a SINIS refrigerator below,
a solid-state microrefrigerator based on semiconductor—superconductor tunnel junctions, referred to as an Sm-S refrigerator below.

This involves at least the advantage that active heat exchanger technology with characteristics known to be suitable for applications of this kind can be utilised.

According to an embodiment, among said at least one active heat exchangers is at least one NIS refrigerator or SINIS refrigerator that comprises, in the following order from said first end to said second end,
a first contact electrode layer for biasing,
an electrically conductive or semiconductive substrate layer,
a layer of normal metal—insulator—super-conductor tunnel junctions or superconductor—insulator—normal metal—insulator—superconductor tunnel junctions,
a superconductor layer, and
a second contact electrode layer for biasing.

This involves at least the advantage that efficient thermal coupling to the flows of working fluid may be achieved, combined with adequate transfer of heat in the desired direction through the active heat exchanger.

According to an embodiment, said superconductor layer comprises constrictions for limiting the propagation of phonons from the superconductor layer to the layer of normal metal—insulator—superconductor tunnel junctions or superconductor—insulator—normal metal—insulator—superconductor tunnel junctions. This involves at least the advantage that backwards leakage of thermal energy can be reduced in the active heat exchanger.

According to an embodiment, among said at least one active heat exchangers is a solid-state microrefrigerator based on the use of electrons in a standard transistor structure as a gas-equivalent refrigerant that is alternately expanded and compressed in a Carnot cycle to induce cooling. This involves at least the advantage that more versatility can be added to the implementation of active heat exchanger(s).

According to an embodiment, among said at least one active heat exchangers is an electrocaloric cooler. This involves at least the advantage that more versatility can be added to the implementation of active heat exchanger(s).

According to an embodiment, the circulation arrangement comprises a first channel for conducting an inbound stream of working fluid into said mixing chamber and a second channel for conducting an outbound stream of working fluid out of said mixing chamber. The first end of a first active heat exchanger is thermally coupled to said first channel, and the second end of said first active heat exchanger is thermally coupled to said second channel. This involves at least the advantage that the flow of working fluid into the mixing chamber can be directly cooled very effectively.

According to an embodiment, the cryogenic cooling system comprises a set of active heat exchangers, among which is said first active heat exchanger. Each active heat exchanger in said set may then have its first end thermally coupled to said first channel and its second end thermally coupled to said second channel. At least two active heat exchangers in said set may be NIS refrigerators and have the superconductor part of their normal metal—insulator—superconductor tunnel junctions made of superconductors of different transition temperatures. Said at least two NIS refrigerators may be arranged along said first channel into an order of increasing distance from a position at which said working fluid will exit said first channel into said mixing chamber during operation, said order being also an order of increase in said transition temperatures. This involves at least the advantage that the operation of the active heat exchangers in said set can be optimised for the temperatures that are progressively colder towards the coldest part of the dilution refrigerator.

According to an embodiment, the circulation arrangement comprises a second channel for conducting an outbound stream of working fluid out of said mixing chamber and into said still. The first end of a second active heat exchanger may then be thermally coupled to a first part of said second channel. The second end of said second active heat exchanger may be thermally coupled to a second part of said second channel, said second part being further away along said second channel than said first part from a position at which said second channel will draw working fluid from said mixing chamber during operation. This involves at least the advantage that the cooling of working fluid flowing into the mixing chamber can be indirectly boosted, by lowering the temperature of that portion of working fluid into which heat should be absorbed from the inbound flow of working fluid.

According to an embodiment, the cryogenic cooling system comprises one or more first heat couplers coupling the first end of the respective active heat exchanger to the respective portion of the circulated working fluid. This involves at least the advantage that the thermal coupling between the working fluid and the active heat exchanger can be intensified.

According to an embodiment, the cryogenic cooling system comprises one or more second heat couplers coupling the second end of the respective active heat exchanger to the respective portion of the circulated working fluid. This involves at least the advantage that the thermal coupling between the working fluid and the active heat exchanger can be intensified.

According to an embodiment, at least one of said heat couplers comprises a volume of sintered thermal conductor material in a space that forms a part of the respective channel. This involves at least the advantage that well-known and proven technology can be used for implementing the heat coupler(s).

According to an embodiment, at least one of said heat couplers comprises a structured internal surface made of a thermal conductor material on one or more walls of a space that forms a part of the respective channel, said structured internal surface being formed by an additive manufacturing process and comprising a plurality of extended thermal conduction paths in the form of regularly shaped portions of said thermal conductor material that extend through a majority of a structured thickness of said internal surface. This involves at least the advantage that one may utilize effective heat-coupling structures that would not be possible to realize with other manufacturing technologies.

### BRIEF DESCRIPTION OF THE DRAWINGS

The accompanying drawings, which are included to provide a further understanding of the invention and constitute a part of this specification, illustrate embodiments of the invention and together with the de scription help to explain the principles of the invention. In the drawings:

FIG. 1 illustrates a cryostat with cryogen-free cooling according to known technology,

FIG. 2 illustrates a known dilution refrigerator,

FIG. 3 illustrates heat flows in the dilution refrigerator of FIG. 2,

FIG. 4 illustrates a dilution refrigerator according to an embodiment,

FIG. 5 illustrates a dilution refrigerator according to an embodiment,

FIG. 6 illustrates a dilution refrigerator according to an embodiment,

FIG. 7 illustrates a dilution refrigerator according to an embodiment,

FIG. 8 illustrates a dilution refrigerator according to an embodiment,

FIG. 9 illustrates a dilution refrigerator according to an embodiment, and

FIG. 10 illustrates a cryogenic cooling system according to an embodiment.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined by the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

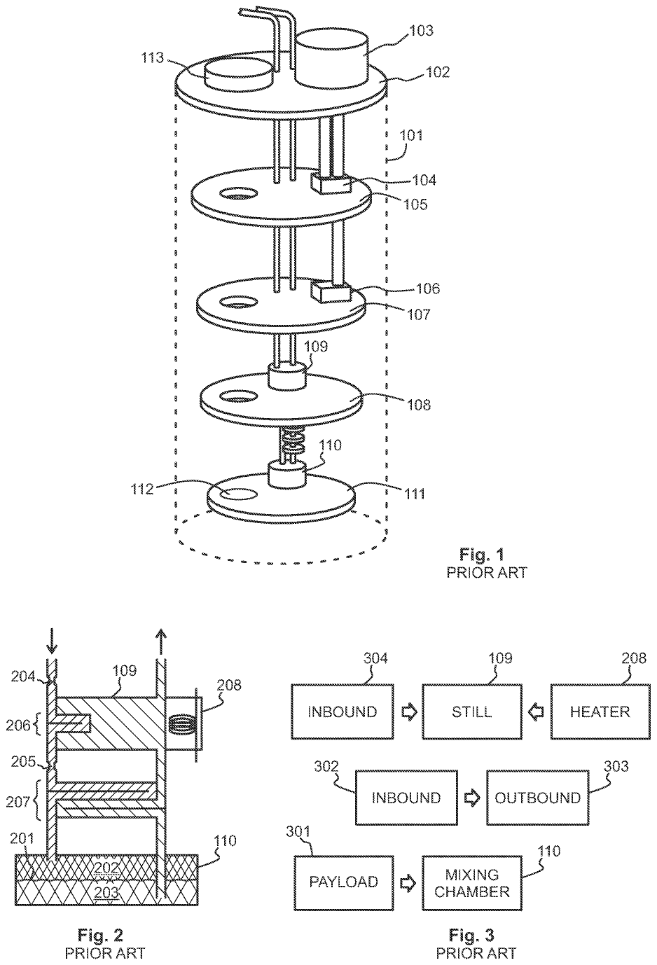

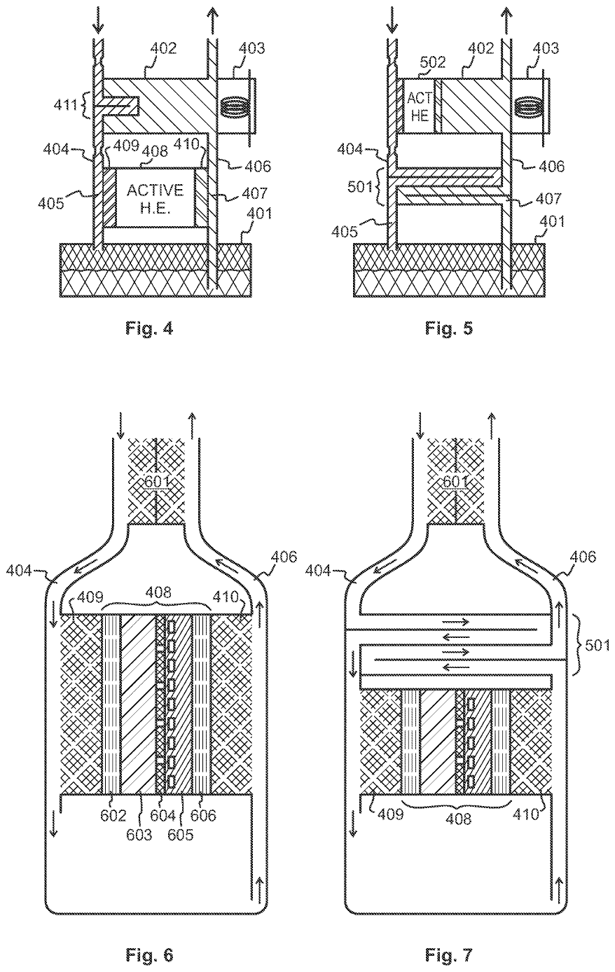

FIG. 4 illustrates a dilution refrigerator that forms a part of a cryogenic cooling system. Parts of the dilution refrigerator are a mixing chamber 401, a still 402, and a circulation arrangement for circulating working fluid through the mixing chamber 401 and the still 402. Also shown in FIG. 4 is a still heater 403. In the arrangement shown in FIG. 4, the circulation arrangement comprises, among others, a first channel 404 for conducting an inbound stream 405 of working fluid into the mixing chamber 401 and a second channel 406 for conducting an outbound stream 407 of working fluid out of the mixing chamber 401. All these parts may resemble the correspondingly illustrated parts in the dilution refrigerator according to prior art in FIG. 2 above.

As a difference to FIG. 2, the cryogenic cooling system of FIG. 4 comprises an active heat exchanger 408 that has a first end (on the left in FIG. 4) and a second end (on the right in FIG. 4). The heat exchanger 408 being an active heat exchanger means that it is configured to use input energy to transfer heat from the first end to the second end during operation.

Contrary to passive heat exchangers, which rely simply on the second law of thermodynamics, allowing two entities of different temperature to inherently seek thermal equilibrium, an active heat exchanger is a device that uses input energy to transfer heat from its first end to its second end during operation. Examples of active heat exchanger types that may be used in the way shown in FIG. 4 are described in more detail later in this text.

The principle of thermally coupling the active heat exchanger 408 to the parts of the dilution refrigerator is important in FIG. 4. The first and second ends of the active heat exchanger 408 are thermally coupled to respective positions along the circulation arrangement for transferring heat between respective portions of the circulated working fluid. This way the working fluid can be used, in addition to its normal use as the working fluid of the dilution refrigerator, as a heat transfer fluid that eventually transfers further away the heat that was transferred across the active heat exchanger to its second end.

In particular, in the configuration shown in FIG. 4, the first end of the active heat exchanger 408 is thermally coupled to the first channel 404, and the second end of the active heat exchanger 408 is thermally coupled to the second channel 406. Consequently, the active heat exchanger 408 is configured to transfer heat between the inbound stream 405 of working fluid and the outbound stream 407 of working fluid. The working fluid in the inbound stream 405 may have a temperature like 100 mK and the working fluid in the outbound stream 407 may have a temperature like 10 mK-30 mK. If some heat may be transferred from the inbound stream 405 to the outbound stream 407, the working fluid eventually flowing into the mixing chamber 401 may be made colder. This in turn enables the mixing chamber 401 to reach a lower base temperature during operation and/or to absorb heat more effectively from the payload for the cooling of which the dilution refrigerator is there. The fact that the outbound stream 407 of working fluid warms up more than it would without the active heat exchanger 408 does not matter, because further up in the dilution refrigerator the working fluid flowing out of the mixing chamber will warm up anyway.

It should be noted that while FIG. 4 shows the location of the active heat exchanger 408 as being somewhere between the mixing chamber 401 and the still 402, this is only for graphical clarity. More important are the thermal couplings of the ends of the active heat exchanger to parts of the circulation arrangement.

In the schematic illustration of FIG. 4, the cryogenic cooling system comprises a first heat coupler 409 that couples the first end of the active heat exchanger 408 to the inbound stream 405 of working fluid. Similarly, the cryogenic cooling system comprises a second heat coupler 410 that couples the second end of the active heat exchanger 408 to the outbound stream 407 of working fluid. Examples of how such heat couplers may be constructed are described in more detail later in this text.

Additionally, the cryogenic cooling system of FIG. 4 comprises a passive heat exchanger 411 between the first channel 405 and the still 402. At this level, the incoming working fluid flowing towards the mixing chamber 401 is warmer than the working fluid in the still 402, so the purpose of the passive heat exchanger 411 is to transfer heat from an upper part of the inbound stream 405 of working fluid to the body of working fluid in the still 402. As the still 402 forms topologically a part of the circulation arrangement for working fluid, also the passive heat exchanger 411 may be said to transfer heat between respective portions of the circulated working fluid.

FIG. 5 illustrates parts of another cryogenic cooling system that resembles that of FIG. 4 otherwise but the location and roles of the two heat exchangers are the other way round. A passive heat exchanger 501 is coupled between the first channel 404 and the second channel 406 in the portion of the dilution refrigerator between the mixing chamber 401 and the still 402. An active heat exchanger 502 is coupled between an upper part of the first channel 404 and the still 402. Functionally, their purposes are the same as in FIG. 4: both transfer heat between respective portions of the circulated working fluid, in order to make the working fluid that eventually enters the mixing chamber 401 as cold as possible.

One possible form of an active heat exchanger 408 or 502 is a solid-state microrefrigerator based on the use of electrons in a standard transistor structure as a gas-equivalent refrigerant that is alternately expanded and compressed in a Carnot cycle to induce cooling. Such an active heat exchanger is known for example from a patent publication US20220208644A1, which is incorporated herein by reference.

Another possible form of an active heat exchanger 408 or 502 is an electrocaloric cooler. Such an active heat exchanger is known for example from a scientific publication Adriana Greco, Claudia Masselli: “Electrocaloric Cooling: A Review of the Thermodynamic Cycles, Materials, Models, and Devices”, Magnetochemistry 2020, 6, 67; doi:10.3390/magnetochemistry 6040067, which is incorporated herein by reference.

Another possible form of an active heat exchanger 408 or 502 is a solid-state microrefrigerator based on normal metal—insulator—superconductor tunnel junctions, superconductor—insulator—normal metal—insulator—superconductor tunnel junctions, or semiconductor—superconductor tunnel junctions. Such active heat exchangers are frequently referred to as NIS refrigerators, SINIS refrigerators, or Sm-S refrigerators respectively. Examples of NIS refrigerators are known for example from a patent publication U.S. Pat. No. 6,581,387B1, which is incorporated herein by reference. Examples of Sm-S refrigerators are known for example from a scientific publication Emma Mykkänen et al: “Thermionic junction devices utilizing phonon blocking”, Sci. Adv. 2020; 6: eaax 9191 10 Apr. 2020, which is incorporated herein by reference.

FIG. 6 illustrates a part of a cryogenic cooling system in which a NIS refrigerator, a SINIS refrigerator, or an Sm-S refrigerator is used as an active heat exchanger in the same way as the active heat exchanger 408 shown in FIG. 4. For conciseness of reference, the active heat exchanger is only referred to as a NIS refrigerator in the following.

The vessel shown in FIG. 6 acts as a mixing chamber of a dilution refrigerator. A first channel 404 is provided on the left for conducting an inbound stream of working fluid into the mixing chamber. A second channel 406 is provided on the right for conducting an outbound stream of working fluid out of the mixing chamber. In the upper part of the vessel, a sintered entity 601 is schematically shown as implementing a passive heat exchanger between the inbound and outbound streams of working fluid.

The NIS refrigerator 408 of FIG. 6 has a layered structure. A first contact electrode layer 602, made of gold, copper, or other material that is both thermally and electrically highly conductive, is provided at the first end of the NIS refrigerator for biasing the NIS refrigerator. Towards the right from the first contact electrode layer 602 in FIG. 6 are an electrically conductive or semiconductive substate layer 603, which may be made of metal or crystalline silicon for example, and a layer 604 of normal metal—insulator—superconductor tunnel junctions. In case of a SINIS refrigerator, the layer 604 comprises superconductor—insulator—normal metal—insulator—superconductor tunnel junctions.

Further towards the right are a superconductor layer 605 as well as a second contact electrode layer 606 for biasing. Similar to the first contact electrode layer 602, the second contact electrode layer 606 is made of gold, copper, or other material that is both thermally and electrically highly conductive. A bias voltage between the first and second contact electrode layers 602 and 606 generates the electric field across the NIS refrigerator 408 that is needed for its proper operation. In addition to said biasing, the second contact electrode layer 606 acts as a quasi-particle trap, for which purpose it is advantageous to place it close to the tunnel junctions.

The operating principle of a NIS (or SINIS, or Sm-S) refrigerator is based on tunnelling. The bias voltage across the NIS refrigerator is set so that only the most energetic, i.e. hottest, electrons may tunnel through the thin insulator layer to the superconductor, lowering the mean electron temperature in the normal metal. The transferred thermal energy may leak back in the opposite direction in the form of phonons, particularly if the overall temperature is too high. However, by keeping the overall temperature low enough and by using certain specific structural solutions, the undesired leakage backwards of thermal energy may be kept under control.

As an example of specific structural solutions, the superconductor layer 605 in FIG. 6 may comprise constrictions for limiting the propagation of phonons from the superconductor layer 605 to the layer 604 of normal metal—insulator—superconductor tunnel junctions (or superconductor—insulator—normal metal—insulator—superconductor tunnel junctions). The constrictions may be made by any known means, for example by patterning the region close to the tunnel junction and by using there suitable materials of varying acoustic impedance. This aims at blocking phonon-based heat transport by reflecting phonons. The reflecting may be emphasized by using meta-materials, meaning layered substances made by atomic layer deposition, in which two or more materials alternate in layers of atomscale thickness. Photolithographic methods are also available for patterning of said kind.

Structural solutions in the NIS-, SINIS-, or Sm-S refrigerator may also comprise one or more of those disclosed in the document US20220272869A1, which is incorporated herein by reference.

The efficiency of cooling that may be achieved with a NIS, SINIS, or Sm-S refrigerator depends, among others, on the superconductor selected for the “S” side of the tunnel junction(s). It is known that the general temperature level at which the NIS, SINIS, or Sm-S refrigerator should operate should be below, and have an appropriate relation to, the critical temperature of the selected superconductor. In a cryogenic cooling system like that in FIG. 6, the general temperature range can be expected to be below 100 mK, because that is the temperature that the inbound stream of working fluid may acquire in the upper (passive) heat exchanger 601. As a rough guideline, it may be advantageous to select the critical temperature of the superconductor at a level of about twice the assumed temperature of the warmer end of the NIS, SINIS, or Sm-S refrigerator during operation.

A first heat coupler 409 is provided for thermally coupling the first end of the active heat exchanger 408 to the portion of circulated working fluid flowing through the first channel 404. Similarly, a second heat coupler 410 is provided for thermally coupling the second end of the active heat exchanger 408 to the portion of circulated working fluid flowing through the second channel 406.

Volumes of sintered thermal conductor material are frequently used as the means for providing an effective thermal coupling between a working fluid and a piece of solid material in cryogenic cooling systems. Thus, also here, at least one of the first and second heat couplers 409 and 410 may comprise a volume of sintered thermal conductor material in a space that forms a part of the respective channel. The use of sintered thermal conductor material is based on the fact that in sintered form, the material provides a relatively large overall contact surface at which heat may flow between the working fluid and the solid material. Simultaneously, thermal conduction paths through the sintered material allow heat to flow between the volume of sintered material and the solid surface to which it is attached.

Additionally or alternatively, at least one of the first and second heat couplers 409 and 410 may comprise a structured internal surface made of a thermal conductor material on one or more walls of a space that forms a part of the respective channel. Said structured internal surface may have been formed by an additive manufacturing process and may comprise a plurality of extended thermal conduction paths in the form of regularly shaped portions of the thermal conductor material that extend through a majority of a structured thickness of said internal surface. The purpose is the same as with sintered material, i.e. to offer both a large overall heat transfer surface to the working fluid and to simultaneously provide thermal conduction paths to the solid surface beneath. Structured internal surfaces of this kind are known for example from the patent publication EP3910276, which is incorporated herein by reference.

FIG. 7 illustrates a part of a cryogenic cooling system in which a NIS refrigerator or a SINIS refrigerator is used as an active heat exchanger in the same way as the active heat exchanger 408 shown in FIGS. 4 and 6. For conciseness of reference, the active heat exchanger is again only referred to as a NIS refrigerator in the following.

As an addition to the embodiment shown in FIG. 6, the cryogenic cooling system of FIG. 7 comprises a passive heat exchanger 501 that implements another thermal coupling between the first channel 404 and the second channel 406. In the embodiment of FIG. 7, the passive heat exchanger 501 is further away (measured along the first channel 404) than the active heat exchanger 408 from the position at which the working fluid exits the first channel 404 into the mixing chamber during operation. Also, the passive heat exchanger 501 is further away (measured along the second channel 406) from the position at which the second channel 406 draws working fluid from the mixing chamber during operation. In other words, the passive heat exchanger 501 is at a slightly warmer location than the active heat exchanger 408 regarding the temperature of the working fluid flowing through the first and second channels 404 and 406. Additionally or alternatively, there could be a passive heat exchanger between the first and second channels 404 and 406 below the active heat exchanger 408, i.e. closer to the position at which the working fluid exits the first channel 404 into the mixing chamber and the position at which the second channel 406 draws working fluid from the mixing chamber during operation.

FIG. 8 illustrates a part of a cryogenic cooling system in which a set of NIS refrigerators and/or SINIS refrigerators 408, 801, and 802 are used as active heat exchangers in the same way as the single active heat exchanger 408 shown in FIGS. 4 and 6.

Each of the active heat exchangers 408, 801, 802 has its first end thermally coupled to the first channel 404 and its second end thermally coupled to the second channel 406. At least two active heat exchangers in the set 408, 801, and 802 are NIS refrigerators or SINIS refrigerators.

As the general temperature levels at which the active heat exchangers 408, 801, and 802 operate are different, the lowest of them operating at the coldest general temperature, it may be advantageous to make the superconductor part of their NIS or SINIS tunnel junctions made of superconductors of different transition temperatures. In particular, as such at least two NIS refrigerators or SINIS refrigerators are in an order of increasing distance along the first channel 404 from the position at which the working fluid exits the first channel 404 into said mixing chamber during operation, it may be advantageous to arrange them also in an order of increase in their transition temperatures.

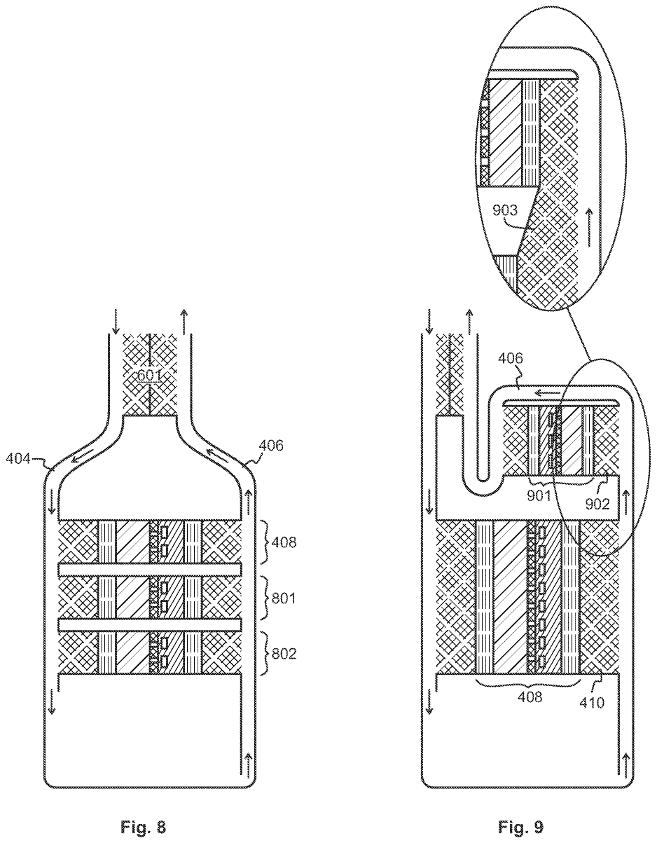

FIG. 9 illustrates a part of a cryogenic cooling system in which a NIS refrigerator or a SINIS refrigerator is used as an active heat exchanger in the same way as the active heat exchanger 408 shown in FIGS. 4 and 6. Additionally, the cryogenic cooling system of FIG. 9 comprises a second NIS refrigerator or SINIS refrigerator 901.

The circulation arrangement of the cryogenic cooling system of FIG. 9 comprises the second channel 406 for conducting an outbound stream of working fluid out of the mixing chamber and into a still, which is not shown in FIG. 9. Instead of being thermally coupled between the first and second channels, the second active heat exchanger 901 is thermally coupled between two locations along the second channel 406. In other words, the first end of the second active heat exchanger 901 is thermally coupled to a first part of the second channel 406 and the second end of the second active heat exchanger 901 is thermally coupled to a second part of said second channel 406. Said second part is further away along the second channel 406 than said first part from the position at which the second channel 406 draws working fluid from the mixing chamber during operation. It is thus important to note that in the graphical representation adopted in FIG. 9, the layers of the NIS refrigerator that is shown as an example of a second active heat exchanger 901 are in a mirrored order compared to those in the first active heat exchanger 408.

The first active heat exchanger 408 is not necessary in the embodiment of FIG. 9, although it may help to achieve the coldest possible base temperature of the mixing chamber. In place of or in addition to the first active heat exchanger 408, one or more similarly coupled passive heat exchangers could be used. Also, there could be a set of active heat exchangers thermally coupled between the first and second channels like in the embodiment of FIG. 8.

The idea of using the second active heat exchanger 901 in FIG. 9 is to transfer heat bound to the outbound stream of working fluid to a further point along the second channel 408 faster than would be possible by just waiting for the working fluid to flow there. As a result of the first end (right-hand end in FIG. 9) of the second active heat exchanger 901 becoming colder, also the second end (right-hand end in FIG. 9) of the first active heat exchanger 408—or whatever other kind(s) of heat exchanger(s) could be there—becomes colder. Assuming that the first active heat exchanger 408—or whatever other kind(s) of heat exchanger(s) could be there—is capable of establishing a certain maximum temperature difference delta-T between its ends, eventually also the first end (left-hand end in FIG. 9) of the first active heat exchanger 408 becomes colder, again helping to acquire and maintain the coldest possible base temperature of the mixing chamber during operation.

In the graphical representation adopted in FIG. 9, the second channel 406 makes a downward bend for the second end (left-hand end) of the second active heat exchanger 901. In practice, it may be advantageous to avoid making the second channel meander up and down, because the working fluid flows in the second channel 406 at least partly under gravitational force due to its thermal gradient. It is relatively straightforward to design the actual path of the second channel so that such meandering is avoided, while still making the appropriate thermal couplings to different parts of the second channel. For example, one may direct the respective parts of the second channel horizontally.

The main drawing in FIG. 9 shows the heat couplers 410 and 902 as separate entities, even if they are next to each other in the longitudinal direction of the second channel 406. In the partial enlargement, a slightly modified embodiment is shown in which there is a unitary heat coupler 903 that makes the thermal couplings both between the second end of the first active heat exchanger 408 and the second channel 406 and between the first end of the second active heat exchanger 901 and the second channel 406. This way it may be possible to make the additional cooling effect provided by the second active heat exchanger 901 cool more efficiently the second end of the first active heat exchanger 408.

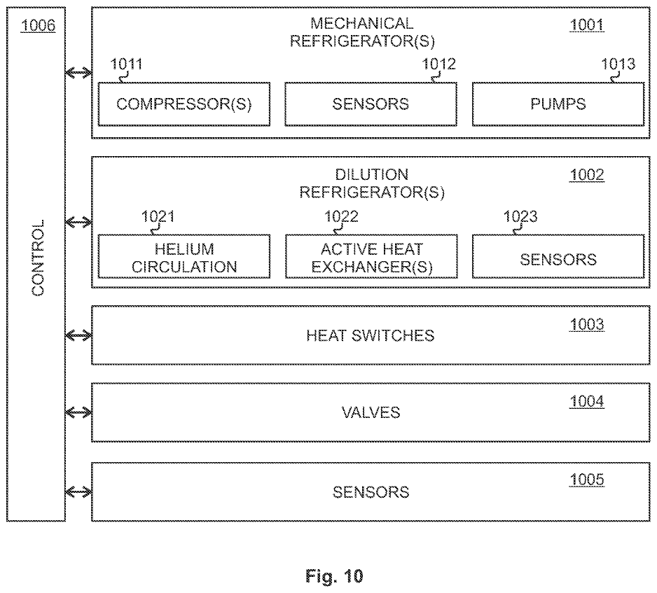

FIG. 10 is a block diagram of a cryogenic cooling system. Main blocks shown in FIG. 10 are the mechanical refrigerator(s) 1001, the dilution refrigerator(s) 1002, heat switches 1003, valves 1004, and sensors 1005 as well as a control system 1006. The mechanical refrigerator(s) block comprises at least compressor(s) 1011, sensors 1012, and pumps 1013. In place of (or in addition to) mechanical refrigerator(s), one may use refrigeration based on liquid cryogens, such as added and/or circulated liquid helium from an external source for example. The dilution refrigerator(s) block 1002 comprises subsystems such as at least the helium circulation 1021, active heat exchanger(s) 1022, and sensors 1023. The active heat exchanger(s) subsystem comprises one or more active heat exchangers located and operated like described above with reference to any of FIGS. 4 to 9. The control system 1006 provides, among others, the bias voltages that are taken through appropriate cabling into the vacuum chamber of the cryogenic cooling system and down to the active heat exchanger(s). The control system 1006 adapts its operation in accordance with the sensor signals it receives from a variety of sensors, including those represented by blocks 1012, 1023, and 1005 in FIG. 10.

It is obvious to a person skilled in the art that with the advancement of technology, the basic idea of the invention may be implemented in various ways. The invention and its embodiments are thus not limited to the examples described above, instead they may vary within the scope of the claims.

1. A cryogenic cooling system, comprising:
a dilution refrigerator, said dilution refrigerator including a mixing chamber (401), a still (402), and a circulation arrangement for circulating working fluid through said mixing chamber (401) and still (402);
wherein the cryogenic cooling system comprises at least one active heat exchanger (408, 801, 802, 901) that has a first end and a second end and that is configured to use input energy to transfer heat from the first end to the second end during operation; and
wherein said first and second ends of the at least one active heat exchanger (408, 801, 802, 901) are thermally coupled to respective positions along said circulation arrangement for transferring heat between respective portions of the circulated working fluid.

2. A cryogenic cooling system according to claim 1, wherein among said at least one active heat exchangers (408, 801, 802, 901) is at least one of:
a solid-state microrefrigerator based on normal metal—insulator—superconductor tunnel junctions,
a solid-state microrefrigerator based on superconductor—insulator—normal metal—insulator—superconductor tunnel junctions,
a solid-state microrefrigerator based on semiconductor—superconductor tunnel junctions.

3. A cryogenic cooling system according to claim 2, wherein among said at least one active heat exchangers (408, 801, 802, 901) is at least one solid-state microrefrigerator based on normal metal—insulator—superconductor tunnel junctions or one solid-state microrefrigerator based on superconductor—insulator—normal metal—insulator—superconductor tunnel junctions that comprises, in the order from said first end to said second end, a first contact electrode layer (602) for biasing, an electrically conductive or semiconductive substrate layer (603), a layer (604) of normal metal—insulator—superconductor tunnel junctions or superconductor—insulator—normal metal—insulator—superconductor tunnel junctions, a superconductor layer (605), and a second contact electrode layer (606).

4. A cryogenic cooling system according to claim 3, wherein said superconductor layer (605) comprises constrictions for limiting the propagation of phonons from the superconductor layer (605) to the layer (604) of normal metal—insulator—superconductor tunnel junctions or superconductor—insulator—normal metal—insulator—superconductor tunnel junctions.

5. A cryogenic cooling system according to claim 1, wherein among said at least one active heat exchangers (408, 801, 802, 901) is a solid-state microrefrigerator based on the use of electrons in a standard transistor structure as a gas-equivalent refrigerant that is alternately expanded and compressed in a Carnot cycle to induce cooling.

6. A cryogenic cooling system according to claim 1, wherein among said at least one active heat exchangers (408, 801, 802, 901) is an electrocaloric cooler.

7. A cryogenic cooling system according to claim 1, wherein the circulation arrangement comprises a first channel (404) for conducting an inbound stream (405) of working fluid into said mixing chamber (401) and a second channel (406) for conducting an outbound stream (407) of working fluid out of said mixing chamber (401), the first end of a first active heat exchanger (408) is thermally coupled to said first channel (404), and the second end of said first active heat exchanger (408) is thermally coupled to said second channel (406).

8. A cryogenic cooling system according to claim 7, wherein the cryogenic cooling system comprises a set of active heat exchangers (408, 801, 802), among which is said first active heat exchanger (408), each active heat exchanger in said set (408, 801, 802) has its first end thermally coupled to said first channel (404) and its second end thermally coupled to said second channel (406), at least two active heat exchangers in said set (408, 801, 802) are NIS refrigerators and have the superconductor part of their normal metal—insulator—superconductor tunnel junctions made of superconductors of different transition temperatures, and said at least two NIS refrigerators are arranged along said first channel (404) into an order of increasing distance from a position at which said working fluid will exit said first channel (404) into said mixing chamber during operation, said order being also an order of increase in said transition temperatures.

9. A cryogenic cooling system according to claim 1, wherein the circulation arrangement comprises a second channel (406) for conducting an outbound stream (407) of working fluid out of said mixing chamber (401) and into said still (402), the first end of a second active heat exchanger (901) is thermally coupled to a first part of said second channel (406), and the second end of said second active heat exchanger (901) is thermally coupled to a second part of said second channel (406), said second part being further away (401) along said second channel (406) than said first part from a position at which said second channel (406) will draw working fluid from said mixing chamber during operation.

10. A cryogenic cooling system according to claim 1, comprising one or more first heat couplers (409) coupling the first end of the respective active heat exchanger (408) to the respective portion of the circulated working fluid.

11. A cryogenic cooling system according to claim 1, comprising one or more second heat couplers (410) coupling the second end of the respective active heat exchanger (408) to the respective portion of the circulated working fluid.

12. A cryogenic cooling system according to claim 10, wherein at least one of said heat couplers (409, 410) comprises a volume of sintered thermal conductor material in a space that forms a part of the respective channel.

13. A cryogenic cooling system according to claim 10, wherein at least one of said heat couplers (409, 410) comprises a structured internal surface made of a thermal conductor material on one or more walls of a space that forms a part of the respective channel, said structured internal surface comprising a plurality of extended thermal conduction paths in the form of regularly shaped portions of said thermal conductor material that extend through a majority of a structured thickness of said internal surface.
